(19) United States
(12) Patent Application Publication
(10) Pub. No.: US 2016/0171483 A1
(43) Pub. Date: Jun. 16, 2016

(54) PAYMENT CARD SUSPENSION

(71) Applicant: OP-Palvelut Oy, Helsinki (FI)

(72) Inventors: Kristian Luoma, Helsinki (FI); Tuomas Jomppanen, Helsinki (FI); Jukka Vayrynen, Helsinki (FI); Jussi Juntunen, Helsinki (FI)

(21) Appl. No.: 14/964,268

(22) Filed: Dec. 9, 2015

(30) Foreign Application Priority Data
Dec. 11, 2014 (FI) 20146083

(51) Int. Cl. G06Q 20/34; G06Q 20/20; G06Q 20/32; G06Q 20/40

(52) U.S. Cl. CPC G06Q 20/34; G06Q 20/405; G06Q 20/204; G06Q 20/3224

(57) ABSTRACT

Payment card suspension is disclosed. A mobile apparatus maintains card data relating to a payment card. The mobile apparatus also receives, with a wireless transceiver, transaction data relating to a payment with the payment card. The transaction data includes retailer location data. The mobile apparatus obtains, with a positioning interface, user location data. If the location of the mobile apparatus as indicated by the user location data deviates from the location of the retailer as indicated by the retailer location data at least by a predetermined distance, the payment card is suspended and the user is informed about the suspension of the payment card with a user interface.

### FIELD OF THE INVENTION

The invention relates to a mobile apparatus, a computer readable medium storing computer program code for a mobile apparatus, and a method, all of them implementing a payment card suspension under certain circumstances.

### BACKGROUND OF THE INVENTION

For years, payment card fraud has plagued the society. Despite o heavy investments in understanding its data and patterns, fraud still persists.

### SUMMARY OF THE INVENTION

According to an aspect of the present invention, there is provided a mobile apparatus comprising: a user interface; a wireless transceiver; a positioning interface; one or more processors; and one or more memories including computer program code; the one or more memories and the computer program code configured to, with the one or more processors, cause the mobile apparatus at least to: maintain card data relating to a payment card of a user; receive, with the wireless transceiver, transaction data relating to a payment with the payment card of a trade of a commodity between the user and a retailer, the transaction data originating from a point of sale system of the retailer and comprising retailer location data determining a geographical location of the retailer; obtain, with the positioning interface, user location data determining a geographical location of the mobile apparatus of the user; and if the location of the mobile apparatus of the user as indicated by the user location data deviates from the location of the retailer as indicated by the retailer location data at least by a predetermined distance, suspend the payment card utilizing the card data by transmitting suspension data, with the wireless transceiver, to an electronic service related to the payment card, and inform, with the user interface, the user about the suspension of the payment card.

According to another aspect of the present invention, there is provided a non-transitory computer-readable storage medium comprising computer program code which, when loaded into a mobile apparatus causes the mobile apparatus at least to: maintain card data relating to a payment card of a user; receive transaction data relating to a payment with the payment card of a trade of a commodity between the user and a retailer, the transaction data originating from a point of sale system of the retailer and comprising retailer location data determining a geographical location of the retailer; obtain user location data determining a geographical location of the mobile apparatus of the user; and if the location of the mobile apparatus of the user as indicated by the user location data deviates from the location of the retailer as indicated by the retailer location data at least by a predetermined distance, suspend the payment card utilizing the card data by transmitting suspension data to an electronic service related to the payment card, and inform the user about the suspension of the payment card.

According to another aspect of the present invention, there is provided a method comprising: maintaining card data relating to a payment card of a user; receiving transaction data relating to a payment with the payment card of a trade of a commodity between the user and a retailer, the transaction data originating from a point of sale system of the retailer and comprising retailer location data determining a geographical location of the retailer; obtaining user location data determining a geographical location of the mobile apparatus of the user; and if the location of the mobile apparatus of the user as indicated by the user location data deviates from the location of the retailer as indicated by the retailer location data at least by a predetermined distance, suspending the payment card utilizing the card data by transmitting suspension data to an electronic service related to the payment card, and informing the user about the suspension of the payment card.

### BRIEF DESCRIPTION OF THE DRAWINGS

Example embodiments of the present invention are described below, by way of example only, with reference to the accompanying drawings, in which

FIG. 1 illustrates an example embodiment of a general operating environment;

FIGS. 2 and 3 illustrate example embodiments of a mobile apparatus;

FIGS. 4, 5, 6 and 7 illustrate example embodiments of a user interface dealing with transaction data and possible payment card suspension; and

FIG. 8 is a flow chart illustrating example embodiments of a method.

### DETAILED DESCRIPTION OF THE INVENTION

The following embodiments are only examples. Although the specification may refer to “an” embodiment in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

It should be noted that while Figures illustrate various embodiments of apparatuses, they are simplified block diagrams that only show some structures and functional entities. The connections shown in these Figures are logical connections; the actual physical connections may be different. Interfaces between the various elements may be implemented with suitable interface technologies, such as a message interface, a method interface, a sub-routine call interface, a block interface, or any hardware/software means enabling communication between functional sub-units. It is apparent to a person skilled in the art that the described apparatuses may also comprise other functions and structures. It should be appreciated that details of some functions, structures, and the protocols used for communication are irrelevant to the actual invention. Therefore, they need not be discussed in more detail here. Although the apparatuses have been depicted as separate single entities, different parts may be implemented in one or more physical or logical entities.

FIG. 1 illustrates an example embodiment of a general operating environment. A customer 100 interacts with at least one seller (=a provider of commodity) 112. The customer 100 has in his/her possession at least one payment card 102 and a mobile apparatus 104. The customer 100 purchases a commodity from the seller 112 and makes a payment 120 with his/her payment card 102.

The customer 100 may also be known as a user, client, buyer, purchaser, or consumer. The seller 112 may also be known as a vendor, supplier, or retailer, the term “retailer” highlighting the fact that the trade is business-to-consumer type rather than the business-to-business type.

In an example embodiment, the seller 112 may operate in a shop such as a store, market, or shopping mall, for example.

A trade between the customer 100 and the seller 112 transfers the ownership of the commodity from the seller 112 to the customer 100, and the seller 112 gets the payment 120 in exchange. The commodity is any marketable item produced to satisfy wants or needs, and the commodity comprises (consumer) goods and services.

The payment card 102 may be used by the cardholder 100 and accepted by the seller 112 to make payments 120 for the trade. The use of the payment card 102 for the payment 120 generates transaction data 126, 122.

In an example embodiment, the payment card 102 may be a credit card or a debit (or bank) card, or any other suitable payment medium, for example. In an example embodiment, the payment card 102 may be implemented as a magnetic stripe card, smart card, or a proximity card, or with any other suitable technology, for example. In an example embodiment, the payment card 102 may be linked to an account 118.

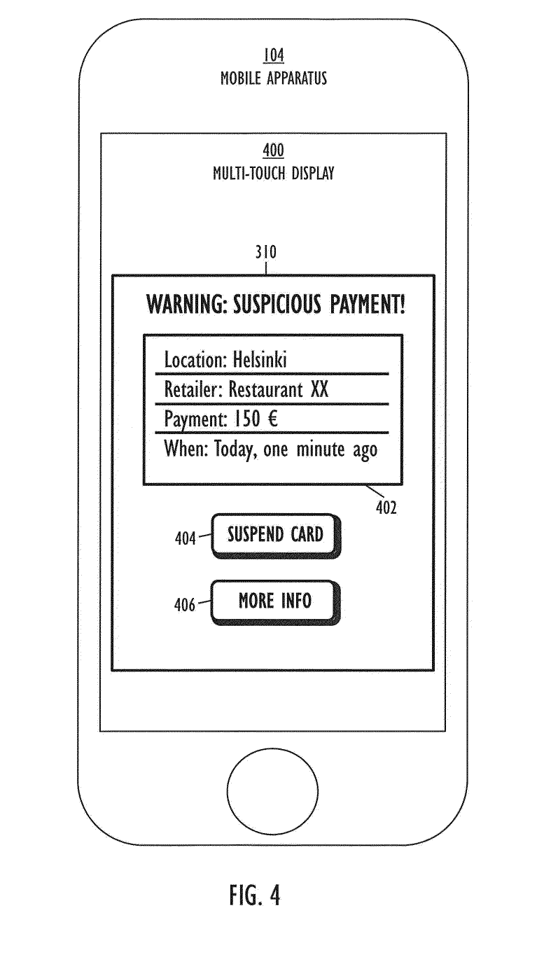

In an example embodiment, the mobile apparatus 104 is a portable electronic communication apparatus. A non-exhaustive list of the types of the mobile apparatus 104 includes: a mobile phone, a smartphone, a tablet computer, a general-purpose mobile computing device. In an example embodiment, the mobile apparatus 104 is a general-purpose off-the-shelf computing device, as opposed to a purpose-build proprietary equipment, whereby research & development costs will be lower as only the special-purpose software (and not the hardware) needs to be designed, implemented and tested. In FIG. 4, an example embodiment of the mobile apparatus 104 is illustrated: the mobile apparatus 104 is a smartphone or a tablet employing a multi-touch display 400. Such devices may employ a suitable operating system such as iOS, Android, or Windows Phone, for example.

In an example embodiment, the seller 112 has a point of sale system 114. In an example embodiment, the point of sale system 114 may be a simple point of sale terminal or it may comprise a number of different hardware and software components. The point of sale system 114 may implement an electronic cash register, and, furthermore possibly also an inventory system, a customer relationship management system etc.

As already explained, the customer 100 makes the payment 120 with his/her payment card 102 to the point of sale system 114 of the seller 112. The point of sale system 114 transmits the transaction(s) to an electronic service 116, which may include a routing/acquiring/issuing bank. As the role of the bank is not very important, the complex structure is depicted with a single entity 116, although the situation may in reality be quite complex. The acquiring bank processes the credit or debit card 102 payment 120, and it acquires credit card payment from the card-issuing banks within an association. The issuing bank offers the (possibly card association branded) payment card 102 to the consumer 100, and it issues the payment 120 to the acquiring bank on behalf of the consumer 100.

As shown in FIG. 1, the electronic service 116 implements the required interaction 122, 124, 126 with the point of sale system 114 and the mobile apparatus 104.

The electronic service 116 may comprise at least one financial system (of a routing/acquiring/issuing bank, for example) but it may also comprise other systems not illustrated in FIG. 1. The electronic service 116 may also comprise, instead of, or in addition to the elements already mentioned, a service provider maintaining the electronic service. The service provider may be an application service provider, which provides the computer-based service with Internet hosting for the customers 100, sellers 112 and financial institutions. In an example embodiment, the service provider is the applicant, OP-Pohjola Group, or some other financial institution. It is also to be noted that the integration grade within the electronic service 116 may change: every element may be a separate actor, or one or more elements may be combined to a multi-actor element.

In an example embodiment, the electronic service 116 may be implemented by a suitable computing resource or a combination of various computing resources. In an example embodiment, the computing resource may be implemented as a single server computer or as a cluster of computers. The server is a part of the client-server computing model that acts as distributed application which partitions tasks or workloads between the provider of a resource or service, called server, and the service requester, called client. The server may serve both the mobile apparatus 104 and the point of sale system 114. The server computer is a host that is running one or more server programs which share their resources with clients 104, 114. The client 104, 114 may request a server's content or service function. The client 104, 114 therefore initiates a communication session with the server 116 which awaits incoming requests.

The electronic service 116 may also operate according to the cloud computing model, at least in part. Naturally, besides these example embodiments of the electronic service 116, other feasible computing architectures may be utilized as well to implement the hardware and software of the electronic service 116. Consequently, besides operating according to the client/server architecture, push technology may be utilized as well. In push technology, the request for a transaction is initiated by the electronic service 116, whereas with the pull technology the request for the information is initiated by the client 104, 114.

In an example embodiment, the transaction data 126 comes to the electronic service 116 directly from the point of sale system 114, or via an intermediary such as a bank or another financial institution.

In an example embodiment, the transaction data 122 may be transmitted from the electronic service 116 to the mobile apparatus 104 in a wireless connection. In an example embodiment, the transaction data 122 is transmitted utilizing a plurality of data packets, for example. The packet may include control information and the actual payload. The term “packet” also includes the possibility that messages are used, i.e., the data is divided into messages, which, in turn, are transported by the packets.

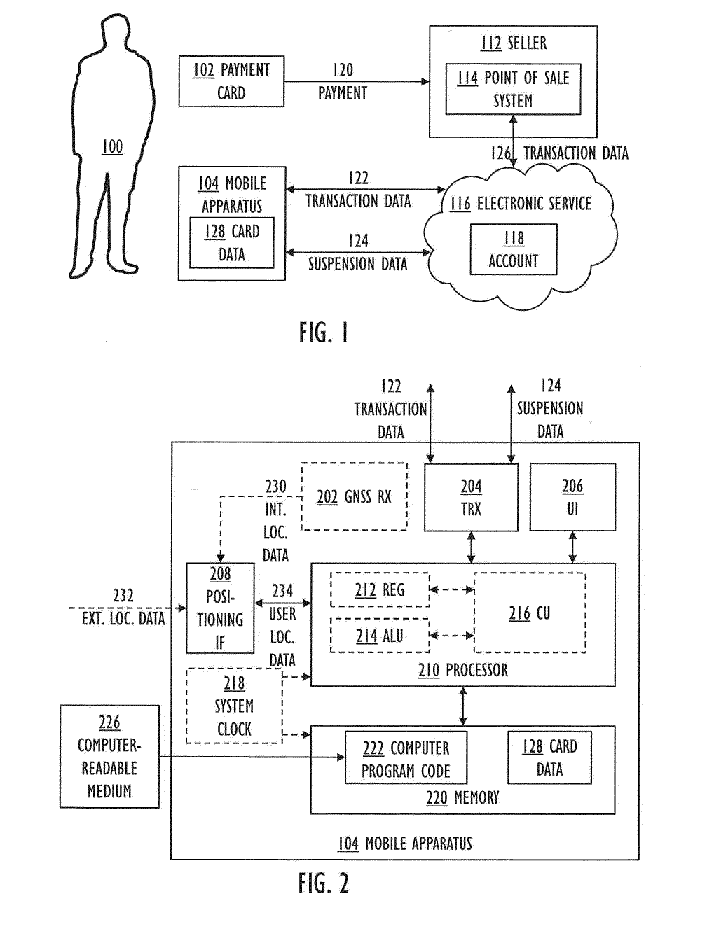

FIG. 2 illustrates example embodiment of the mobile apparatus 104 for processing of the transaction data 122. The mobile apparatus 104 comprises a user interface 206, a wireless transceiver 204, a positioning interface 208, one or more processors 210, and one or more memories 220 including computer program code 222.

In an example embodiment, the user interface 206 implements the exchange of graphical, textual and auditory information with the customer 100. The user interface 206 may be realized with various techniques, such as a display 400, means for producing sound, a keyboard, and/or a keypad, for example. The display 400 may be a liquid crystal display (LCD), for example, but it may also be implemented by any appropriate technique, such as with an organic light-emitting diode (OLED) or electroluminescence (EL), for example. The display may also incorporate other user interaction means, such as touch input, or haptic feedback, i.e. the display may be a multi-touch display 400. The means for producing sound may be a loudspeaker or a simpler means for producing beeps or other sound signals. The keyboard/keypad may comprise a complete (QWERTY) keyboard, a mere numeric keypad or only a few push buttons and/or rotary buttons. In addition, the user interface 206 may comprise other user interface components, for example various means for focusing a cursor (mouse, track ball, arrow keys, touch sensitive area etc.) or elements enabling audio control.

In an example embodiment, the wireless transceiver 204 may be interoperable with various wireless standard/non-standard/proprietary communication networks such as any mobile phone network, regardless of the generation (such as 2G, 3G, 4G, beyond 4G, etc.) such as GSM (Global System for Mobile Communications), GPRS (General Packet Radio Service), EGPRS (Enhanced GPRS), WCDMA (Wideband Code Division Multiple Access), UMTS (Universal Mobile Telephone System), 3GPP (The 3rd Generation Partnership Project), IMT (International Mobile Telecommunication), LTE (Long Term Evolution, LTE-A (LTE-Advanced), and other radio systems (in their present forms and/or in their evolution forms), such as WLAN (Wireless Local Area Network) based on IEEE (Institute of Electrical and Electronics Engineers) 802.11 standard or its evolution versions (IEEE 802.11ac etc.), WiMAX (Worldwide Interoperability for Microwave Access, or Wi-Fi, for example.

In an example embodiment, the wireless transceiver 204, while communicating with a mobile phone network, may require a subscriber identity module (SIM), which may be an integrated circuit storing subscriber data, which is network-specific information used to authenticate and identify subscribers on the cellular network. The subscriber identity module may be embedded into a removable SIM card, on a mini-SIM card, for example. Furthermore, the mobile apparatus 104 may include a SIM card reader, for example. Besides being implemented on a SIM card, the subscriber identity module may be implemented with other techniques as well, such as a virtual/embedded SIM.

In an example embodiment, the positioning interface 208 outputs user location data 234, which is based either on internal location data 230 or on external location data 232. In an example embodiment, the mobile apparatus 104 further comprises a global navigation satellite system (GNSS) receiver 202 producing the internal location data 230. In an example embodiment, the receiver 202 is interoperable with GPS (Global Positioning System) of the USA, Galileo of the European Union, GLONASS of Russia, Beidou of China, or IRNSS of India. Besides GNSS, or instead of GNSS, other location techniques may be utilizes as well such as those developed for use in cellular radio networks. Besides generating the location data internally, the mobile apparatus 104 may receive external location data 232, from a cellular radio network, for example.

The term ‘processor’ 210 refers to a device that is capable of processing data. Depending on the processing power needed, the mobile apparatus 104 may comprise several processors 210 such as parallel processors or a multicore processor. When designing the implementation of the processor 210, a person skilled in the art will consider the requirements set for the size and power consumption of the mobile apparatus 104, the necessary processing capacity, production costs, and production volumes, for example. The processor 210 and the memory 220 may be implemented by an electronic circuitry.

The term ‘memory’ 220 refers to a device that is capable of storing data run-time (=working memory) or permanently (=non-volatile memory). The working memory and the non-volatile memory may be implemented by a random-access memory (RAM), dynamic RAM (DRAM), static RAM (SRAM), a flash memory, a solid state disk (SSD), PROM (programmable read-only memory), a suitable semiconductor, or any other means of implementing an electrical computer memory.

In an example embodiment, a system clock 218 constantly generates a stream of electrical pulses, which cause the various transferring operations within the mobile apparatus 104 to take place in an orderly manner and with specific timing.

In an example embodiment, the processor 210 may be implemented as a microprocessor implementing functions of a central processing unit (CPU) on an integrated circuit. The CPU is a logic machine executing a computer program code 222. The computer program code 222 may be coded as a computer program using a programming language, which may be a high-level programming language, such as C, C++, or Java, or a low-level programming language, such as a machine language, or an assembler, for example. The CPU may comprise a set of registers 212, an arithmetic logic unit (ALU) 214, and a control unit (CU) 216. The control unit 216 is controlled by a sequence of the computer program code 222 transferred to the CPU from the (working) memory 220. The control unit 216 may contain a number of microinstructions for basic operations. The implementation of the microinstructions may vary, depending on the CPU design. The microprocessor 210 may also have an operating system (a dedicated operating system of an embedded system, a real-time operating system, or even a general-purpose operating system), which may provide the computer program code 222 with system services.

A non-exhaustive list of implementation techniques for the processor 210 and the memory 220 includes, but is not limited to: logic components, standard integrated circuits, application-specific integrated circuits (ASIC), system-on-a-chip (SoC), application-specific standard products (ASSP), microprocessors, microcontrollers, digital signal processors, special-purpose computer chips, field-programmable gate arrays (FPGA), and other suitable electronics structures.

The computer program code 222 may be implemented by software and/or hardware. In an example embodiment, the software may be written by a suitable programming language, and the resulting executable code 222 may be stored on the memory 220 and run by the processor 210.

In an example embodiment, the functionality of the hardware may be designed by a suitable hardware description language (such as Verilog or VHDL), and transformed into a gate-level netlist (describing standard cells and the electrical connections between them), and after further phases the chip implementing the processor 210, memory 220 and the code 222 of the mobile apparatus 104 may be fabricated with photo masks describing the circuitry.

In an example embodiment, the processor 210 and the memory 220 are separate entities, communicatively coupled together by an appropriate serial bus, for example. In general interfaces between the various elements may be implemented with suitable interface technologies, such as a message interface, a method interface, a sub-routine call interface, a block interface, an appropriate serial/parallel bus, or any hardware/software means enabling communication between various sub-units of the mobile apparatus 104.

An example embodiment provides computer program code 222 stored on a computer-readable medium 226, which computer program code 222, when loaded into the mobile apparatus 104 and executed in the mobile apparatus 104, causes the mobile apparatus 104 to perform the processing functionality of the disclosed example embodiments. There are many ways to structure the computer program code 222. In an example embodiment, the operations of the computer program code 222 may be divided into functional modules, sub-routines, methods, classes, objects, applets, macros, etc., depending on the software design methodology and the programming language used. In modern programming environments, there are software libraries, i.e. compilations of ready-made functions, which may be utilized by the computer program code 222 for performing a wide variety of standard operations. In an example embodiment, the computer program code 222 may be in source code form, object code form, executable file, or in some intermediate form. The computer-readable medium 226 may comprise at least the following: any entity or device capable of carrying computer program code 222 to the mobile apparatus 104, a record medium, a computer memory, a read-only memory, an electrical carrier signal, a telecommunications signal, and a software distribution medium. In some jurisdictions, depending on the legislation and the patent practice, the computer-readable medium 226 may not be the telecommunications signal. In an example embodiment, the computer-readable medium 226 may be a non-transitory computer-readable storage medium.

Naturally, the mobile apparatus 104 may include various other parts, such as a battery, a camera, or a radio-frequency identifier reader, but as they are not needed to further illustrate the example embodiments, they will not be further described.

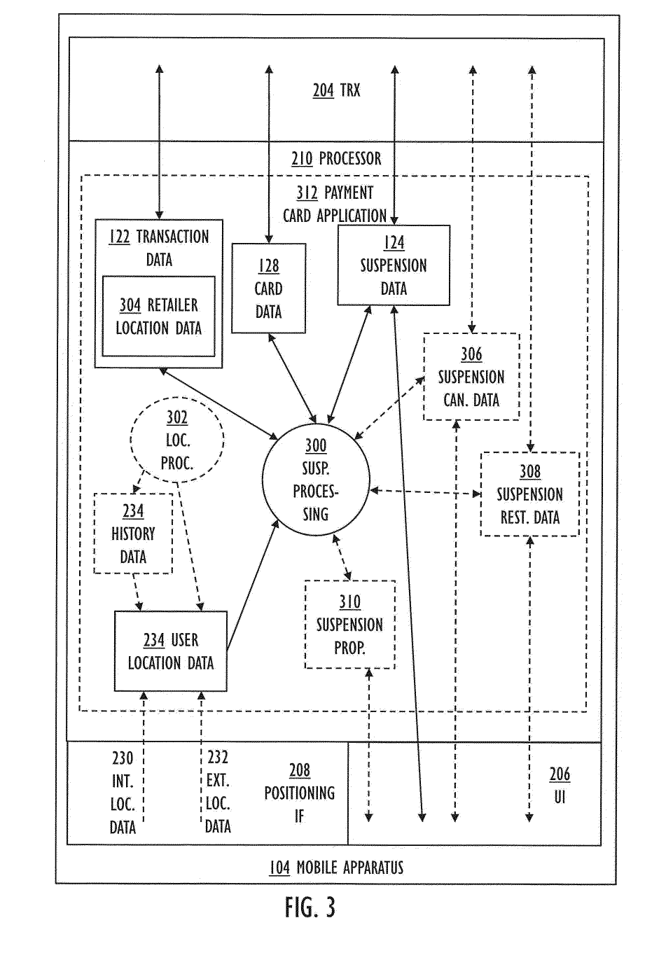

Now that the basic structures of the mobile apparatus 104 have been described, we may proceed in describing the operation of the mobile apparatus 104 in more detail with reference to FIG. 3 giving a more detailed view of the functionality, and FIGS. 4, 5, 6 and 7 illustrating the user interface 206 dealing with the transaction data and possible payment card suspension.

1) The one or more memories 220 and the computer program code 222 are configured to, with the one or more processors 210, cause the mobile apparatus 104 to maintain card data 128 relating to the payment card 102 of the user 100.

2) The one or more memories 220 and the computer program code 222 are configured to, with the one or more processors 210, cause the mobile apparatus 104 to receive, with the wireless transceiver 204, the transaction data 122 relating to the payment 120 with the payment card 102 of a trade of a commodity between the user 100 and the retailer 112. The transaction data 122 originates from the point of sale system 114 of the retailer 112 and comprises retailer location data 304 determining a geographical location of the retailer 112.

3) The one or more memories 220 and the computer program code 222 are configured to, with the one or more processors 210, cause the mobile apparatus 104 to obtain, with the positioning interface 208, user location data 234 determining a geographical location of the mobile apparatus 104 of the user 100.

4) The one or more memories 220 and the computer program code 222 are configured to, with the one or more processors 210, cause the mobile apparatus 104 to, if the location of the mobile apparatus 104 of the user 100 as indicated by the user location data 234 deviates from the location of the retailer 112 as indicated by the retailer location data 304 at least by a predetermined distance, suspend the payment card 102 utilizing the card data 128 by transmitting suspension data 124, with the wireless transceiver 204, to the electronic service 116 related to the payment card 102, and inform, with the user interface 206, the user 100 about the suspension of the payment card 102. The predetermined distance may be determined as an absolute distance, measured in metres, kilometres, or miles for example.

The above-described sequence of four operations makes it possible to prevent payment card 104 fraud by the described suspension processing 300. Basically, here it is checked that the user 100 was present at the premises of the seller 112 to make the payment 120. If the user 100 was elsewhere at the time of the payment 120, it may be deduced by the process 300 that someone else made the payment with an illegal copy of the payment card 102, for example.

In an example embodiment, the transaction data 122 is received in real-time or almost in real-time after the payment 120 with only processing and communication delays. The processing in the point of sale system 114 and in the electronic service 116 as well as the communication from the point of sale system 114 via the electronic service 116 to the mobile apparatus 104 takes some time. Usually these delays remain reasonable, from a few seconds to a maximum of a few minutes, for example.

In an example embodiment, the user location data 234 is retrieved after the transaction data 122 is received. The reception of the transaction data 122 may thus act as a stimulus for retrieving the user location data 234.

In an example embodiment, the user location data 234 is received from a background process 302, which continuously tracks location of the mobile apparatus 104.

In an example embodiment, the transaction data 122 comprises a timestamp determining date and time of the payment 120, and the user location data 234 is retrieved from history data 234 maintained by a background process 302 on the basis of the timestamp. In this way, the possible delays in processing and communication do not distort the outcome: both the retailer location data 304 and the user location data 234 may be compared in the same timeline. For example, if the payment 120 took place on the 8th of December in 2014 at 9:00 o'clock, the user's location at that time may be retrieved from the history data 234, even if the transaction data 122 only arrived at the mobile apparatus 104 four hours later at 12:00 clock.

In an example embodiment, the payment card 102 is suspended automatically. In this way, it does not matter even if the user 100 is not present by his/her mobile apparatus 104 as the suspension is done automatically in order to prevent further payment card 104 frauds.

In an example embodiment, the payment card 102 is suspended automatically if the user is not logged on to an application 312 managing the payment card 102. This means that the suspension is done automatically if the location of the mobile apparatus 102 deviates from the location of the retailer 112 at the time of the payment 120, and the user 100 is not logged on to the application 312, i.e. the automatic suspension is the default. In order to be able to pay normally, the user 100 first logs on to the application 312, and if the location of the mobile apparatus 102 does not deviate from the location of the retailer 112 at the time of the payment 120, the payment 120 is normally executed and debited.

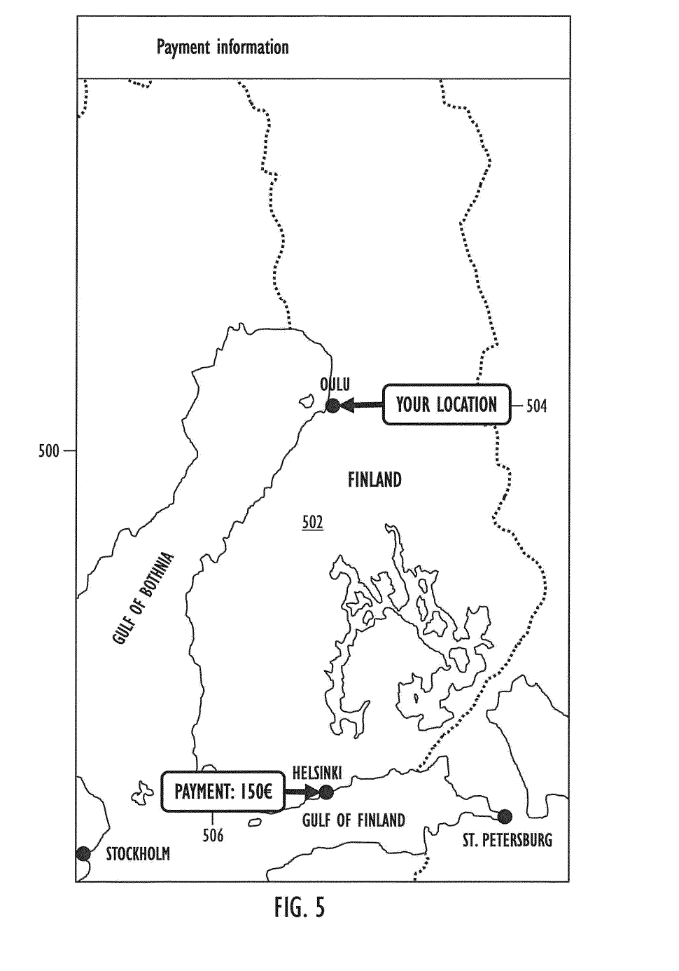

In an example embodiment illustrated in FIG. 4, the payment card 102 is suspended after the user 100 has consented to a suspension proposal 310 in the user interface 400. As can be seen in FIG. 4, someone has made a payment 120 of 150 euros in Restaurant XX located in Helsinki one minute ago. Now, if the user 100 is in Oulu (which is located 600 kilometres north from Helsinki), it is clear that a payment card 102 fraud is about to happen. The user 100 may now consent to the suspension proposal 310 by pressing button 404 in order to authorize the suspension. Alternatively, the user 100 may press button 406 for more information, whereupon the display 500 of FIG. 5 is shown: the location of the user 100 is pointed 504 on a map 502, and also the location of the payment 102 is pointed 506.

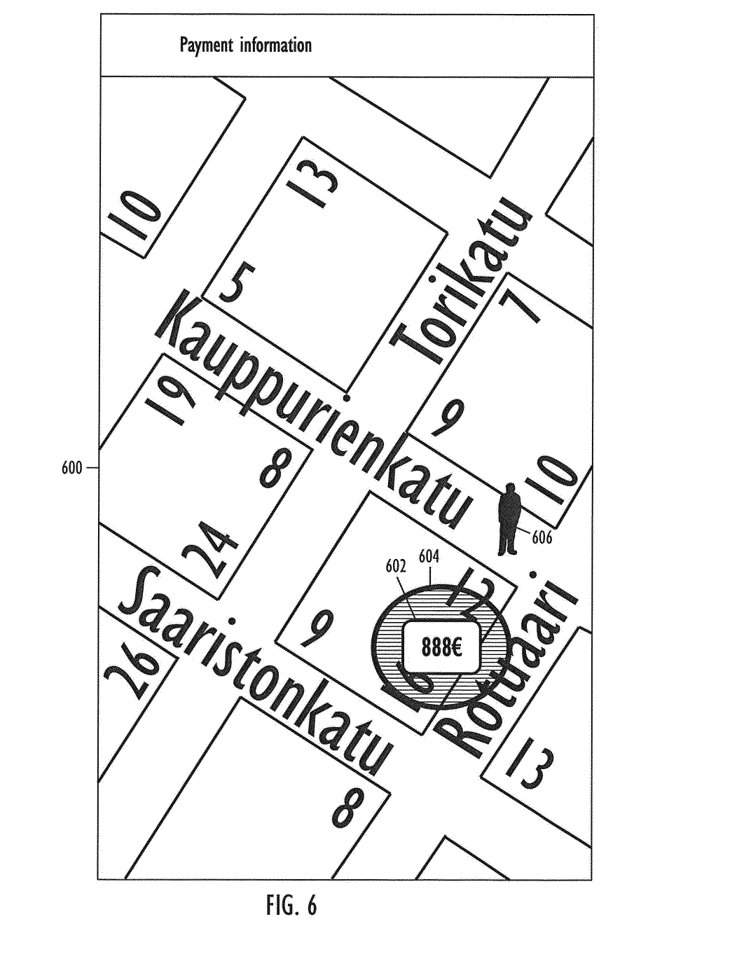

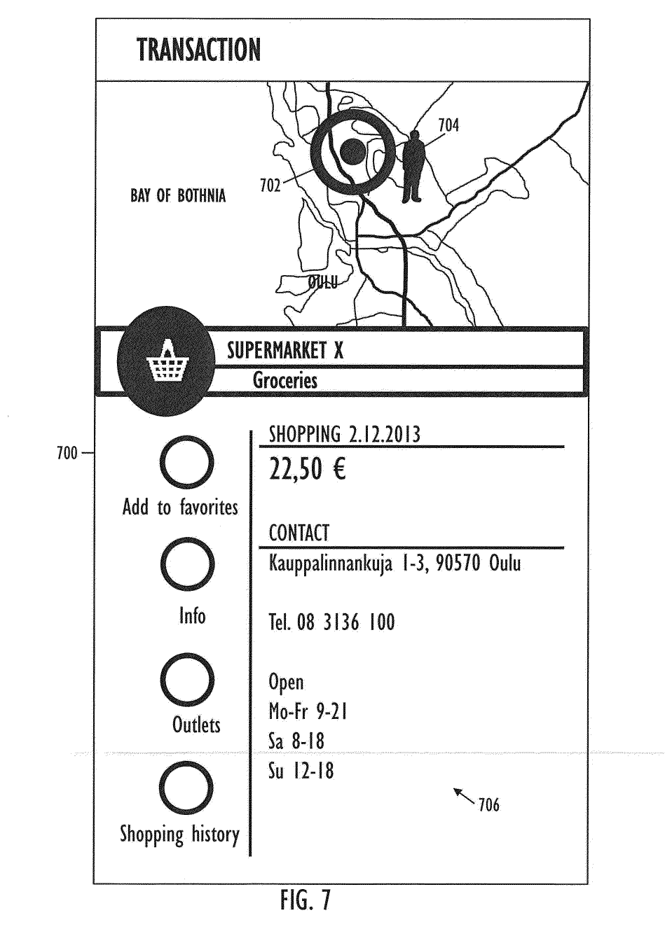

Naturally, the user may zoom into the map as shown with the display 600 of FIG. 6. This display 600 illustrates another, legal payment 602 that took place in premises 604, and, as can be seen, the user 100 has just walked away into a location 606, which is within the predetermined distance, and, therefore, the payment 602 is not suspicious.

In an example embodiment, illustrated in FIG. 7, the described processing is integrated with transaction data processing 122. In an example embodiment, the embodiments are applied within the Pivo electronic wallet mobile application of OP-Pohjola Group, described in other co-pending patent applications Fl 20135155, Fl 20135248, U.S. patent application Ser. No. 14/072,962, Fl 20136196 and Fl 20136241. In display 700 of FIG. 7, the payment 120 took place at a location 702, the user 100 has moved to a location 704, and the transaction data 122 with various details is illustrated 706.

In an example embodiment illustrated in FIG. 3, after the suspension of the payment card 102, the user 100 cancels, with the user interface 206, the suspension of the payment card 102 temporarily, whereupon suspension cancellation data 306 is transmitted, with the wireless transceiver 204, to the electronic service 116 related to the payment card 102, and the user 100 makes a further payment with the payment card 102, and after the further payment is debited, the suspension of the payment card 102 is automatically restored by transmitting suspension restoration data 308, with the wireless transceiver 204, to the electronic service 116 related to the payment card 102. With this kind of processing, the user 100 can still use the payment card 102 for single payments, without risk of further frauds, even if the payment card 102 has been suspended. This is useful if the user 100 is far away from home, or if the banks are closed due to weekend or some other reasons, which make it impossible for the user 100 to obtain a replacement payment card 102 fast.

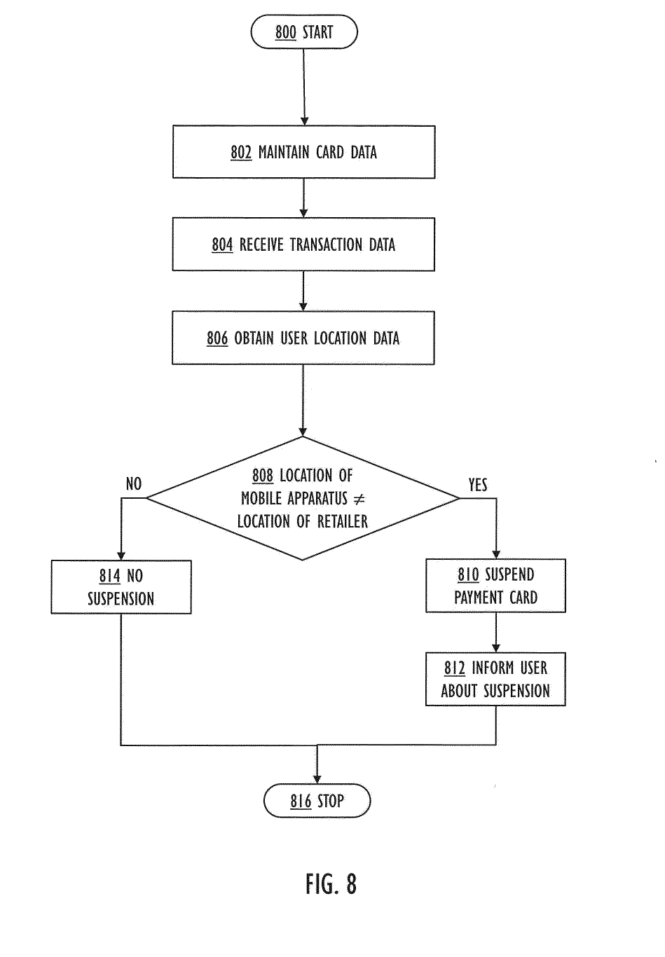

Next, let us study FIG. 8, which is a flow chart illustrating example embodiments of a method. The operations are not strictly in chronological order, and some of the operations may be performed simultaneously or in an order differing from the given ones. Other functions may also be executed between the operations or within the operations and other data exchanged between the operations. Some of the operations or part of the operations may also be left out or replaced by a corresponding operation or part of the operation. It should be noted that no special order of operations is required, except where necessary due to the logical requirements for the processing order. In an example embodiment, the method may be implemented by an electronic apparatus, by the described mobile apparatus 104, for example.

The method starts in 800.

In 802, card data relating to a payment card of a user is maintained.

In 804, transaction data relating to a payment with the payment card of a trade of a commodity between the user and a retailer is received. The transaction data originates from a point of sale system of the retailer and comprises retailer location data determining a geographical location of the retailer.

In 806, user location data determining a geographical location of the mobile apparatus of the user is obtained.

In 808 a test is made: if the location of the mobile apparatus of the user as indicated by the user location data deviates from the location of the retailer as indicated by the retailer location data at least by a predetermined distance, the payment card is suspended 810 utilizing the card data by transmitting suspension data to an electronic service related to the payment card, and the user is informed 812 about the suspension of the payment card.

If the test condition in 808 is not fulfilled, no suspension is made 814.

The method ends in 816.

The already described example embodiments of the mobile apparatus 104 may be utilized to enhance the method.

It will be obvious to a person skilled in the art that, as technology advances, the inventive concept can be implemented in various ways. The invention and its embodiments are not limited to the example embodiments described above but may vary within the scope of the claims.

1. A mobile apparatus comprising:
a user interface;
a wireless transceiver;
a positioning interface;
one or more processors; and
one or more memories including computer program code;
the one or more memories and the computer program code configured to, with the one or more processors, cause the mobile apparatus at least to:
maintain card data relating to a payment card of a user;
receive, with the wireless transceiver, transaction data relating to a payment with the payment card of a trade of a commodity between the user and a retailer, the transaction data originating from a point of sale system of the retailer and comprising retailer location data determining a geographical location of the retailer;
obtain, with the positioning interface, user location data determining a geographical location of the mobile apparatus of the user; and
if the location of the mobile apparatus of the user as indicated by the user location data deviates from the location of the retailer as indicated by the retailer location data at least by a predetermined distance, suspend the payment card utilizing the card data by transmitting suspension data, with the wireless transceiver, to an electronic service related to the payment card, and inform, with the user interface, the user about the suspension of the payment card.

2. The apparatus of claim 1, wherein the transaction data is received in real-time or almost in real-time after the payment with only processing and communication delays.

3. The apparatus of claim 1, wherein the user location data is retrieved after the transaction data is received.

4. The apparatus of claim 1, wherein the user location data is received from a background process, which continuously tracks location of the mobile apparatus.

5. The apparatus of claim 1, wherein the transaction data comprises a timestamp determining date and time of the payment, and the user location data is retrieved from history data maintained by a background process on the basis of the timestamp.

6. The apparatus of claim 1, wherein the payment card is suspended automatically.

7. The apparatus of claim 1, wherein the payment card is suspended automatically if the user is not logged on to an application managing the payment card.

8. The apparatus of claim 1, wherein the payment card is suspended after the user has consented to a suspension proposal in the user interface.

9. The apparatus of claim 1, wherein, after the suspension of the payment card, the user cancels, with the user interface, the suspension of the payment card temporarily, whereupon suspension cancellation data is transmitted, with the wireless transceiver, to the electronic service related to the payment card, and the user makes a further payment with the payment card, and after the further payment is debited, the suspension of the payment card is automatically restored by transmitting suspension restoration data, with the wireless transceiver, to the electronic service related to the payment card.

10. A non-transitory computer-readable storage medium comprising computer program code which, when loaded into a mobile apparatus causes the mobile apparatus at least to:
maintain card data relating to a payment card of a user;
receive transaction data relating to a payment with the payment card of a trade of a commodity between the user and a retailer, the transaction data originating from a point of sale system of the retailer and comprising retailer location data determining a geographical location of the retailer;
obtain user location data determining a geographical location of the mobile apparatus of the user; and
if the location of the mobile apparatus of the user as indicated by the user location data deviates from the location of the retailer as indicated by the retailer location data at least by a predetermined distance, suspend the payment card utilizing the card data by transmitting suspension data to an electronic service related to the payment card, and inform the user about the suspension of the payment card.

11. A method comprising:
maintaining card data relating to a payment card of a user;
receiving transaction data relating to a payment with the payment card of a trade of a commodity between the user and a retailer, the transaction data originating from a point of sale system of the retailer and comprising retailer location data determining a geographical location of the retailer;
obtaining user location data determining a geographical location of the mobile apparatus of the user; and
if the location of the mobile apparatus of the user as indicated by the user location data deviates from the location of the retailer as indicated by the retailer location data at least by a predetermined distance, suspending the payment card utilizing the card data by transmitting suspension data to an electronic service related to the payment card, and informing the user about the suspension of the payment card.
